(19) United States
(12) Patent Application Publication
(10) Pub. No.: US 2009/0274902 A1
(43) Pub. Date: Nov. 5, 2009

(54) Hard Coat Layer Composition and Hard Coat Film

(75) Inventor: Makoto Kume, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/431,703

(22) Filed: Apr. 28, 2009

(30) Foreign Application Priority Data
Apr. 30, 2008 (JP) 2008-118341

(51) Int. Cl. B32B 27/30; C08F 20/22; G02B 1/10

(52) U.S. Cl. 428/336; 522/182; 359/485

(57) ABSTRACT

The present invention provides a hard coat film and a hard coat layer forming composition which forms a hard coat layer adhering well to a substrate, which does not curl up easily and having antifouling properties, excellent abrasion resistance, surface hardness, and a high level of visibility. The present invention has a specific feature in that a hard coat layer forming composition which includes polyfunctional acrylic (or methacrylic) monomer (A), acrylic monomer having a hydroxyl group (B), radical photopolymerization initiator (C), and fluorocompound having a polymerizable group (D) is used. The hard coat film of the present invention has the hard coat layer which is formed by curing the hard coat layer forming composition on a transparent substrate and has a surface free energy less than 20 mN/m and the thickness in the range of 5-25 μm.

### CROSS REFERENCE TO RELATED APPLICATION

This application is based on and claims the benefit of priority from the Japanese Patent Application number 2008-118341, filed on Apr. 30, 2008, the entire contents of which are incorporated herein by reference.

### BACKGROUND OF THE INVENTION

1. Field of the Invention

This invention relates to a hard coat layer forming composition and a hard coat film which protects a surface of a display device such as a cathode ray tube (CRT) display, a liquid crystal display (LCD), a plasma display (PDP), an organic electroluminescent display (OELD) and field emission display (FED). Specifically, this invention relates to a hard coat layer composition and a hard coat film that sticks well to a substrate and does not curl easily as well as has an excellent abrasion resistance and surface hardness.

2. Description of the Related Art

In order to provide various functions, resin layers are formed on a protection film of a polarizing plate on an LCD or a protection film of a circularly polarizing plate on an OELD. For example, an antistatic layer, which provides antistatic properties, an antireflection layer, which provides antireflection properties, and a hard coat layer, which improves surface hardness, etc. are formed on a protection film. In particular, a hard coat layer is essential for a display application since it plays not only its intrinsic role of improving hardness but also a role as a base layer of the reflection layer.

For example, patent document 1 discloses a thermoplastic norbornene resin product which has a silicone series hard coat layer on a surface of a substrate made of thermoplastic norbornene resin, wherein the hard coat layer has adhesiveness of sticking to more than 50 materials (out of 100 test materials) measured by a “grid-peeling” test. Patent document 2 discloses a hard coat film for a plastic film substrate, wherein the hard coat film is formed with coating film components including at least one of organic components having a polymerizable functional group and inorganic filler, and at least one of the organic components does not have a hydrogen bond forming group. Patent document 3 discloses a hard coat film which has a hard coat layer on at least one surface of a substrate film, wherein a hard coat layer forming material contains urethane acrylate (A), isocyanuric acrylate (B) and inorganic particles (C).

In recent years, it is increasingly demanded for such a hard coat film as a protection component of a polarizing plate to improve hardness. It is however difficult to improve hardness of a hard coat film for protection of a polarizing plate because of the softness of a substrate film usually made of cellulose esters. The demand for a high level of hardness of a hard coat film which is arranged with a hard coast layer as a protection function of these polarizing plates is increasing significantly. However, it is difficult to improve hardness of a hard coat film for the protection of a polarizing plate due to the softness of a substrate film which is usually made of cellulose esters.

Moreover, as applications of such a polarizing plate widely spread to LCD televisions and notebook PCs etc., various additional functions have begun to be needed. For example, an antireflection function to avoid reflection of light from a fluorescent lamp, an antistatic function to keep clean from dust, and an antifouling function which allows smears of fingerprints etc. to be easily wiped off are being demanded. In particular, through normal use, smears such as fingerprints, sebum, sweat and cosmetic components etc. are often attached on notebook PCs etc. Polarizing plates having a large surface energy in general are inclined to attach such smears and dust. In addition, due to micro concavities and convexities on a surface of an antireflection film, it is not easy to remove such smears and dust by wiping. To make matters worse, there is problem that such smears and dust reflect light well and are particularly visible.

Hence, to solve this problem, a variety of techniques have been proposed to form an antifouling layer to which smears and dust do not stick easily etc. and can also be easily wiped off, even when they occasionally stick to a surface of an optical component.

For example in patent document 4, it is proposed that an antireflection component having antifouling properties and abrasion resistance is produced by forming an antireflection layer mainly made of silicon dioxide on a surface of a substrate followed by treating the layer's surface with a compound which includes an organosilicon substituent. Similarly in patent document 5, it is proposed that a CRT filter having antifouling properties and abrasion resistance is produced by covering a surface of a substrate with an organic polysiloxane having a silanol-terminal. In addition, in patent document 6, a low reflection antifouled plastic having on the surface thereof an antireflection membrane which includes monosilan and disilane compound having a polyfluoroalkyl group and a halogenated alkylsilane or alkoxysilane compound, is disclosed.

Antifouling layers of conventional methods, however, have insufficient antifouling properties. Particularly, smears of fingerprints, sebum, sweat and cosmetic component etc. cannot be easily wiped off. In addition, as the layer is used for a long period, the antifouling properties decrease significantly.
<Patent Document 1> JP-A-(H) 7-097468
<Patent Document 2> JP-A-2000-159916
<Patent Document 3> JP-A-2006-106427
<Patent Document 4> JP-A-(H) 1-086101 (JP-A-(S) 64-086101)
<Patent Document 5> JP-A-(H) 4-338901
<Patent Document 6> JP-A-(S) 61-247743

Conventionally, there are almost no hard coat films which have antifouling properties such as the capability of sufficiently wiping off fingerprints etc., and if any, the antifouling property is extremely weak. Hence, there is a problem that smears such as fingerprints tend to easily stick to hard coat films, and once they happen to stick, the smears tend to be difficult to remove. Moreover, even if an insufficient antifouling treatment is performed and attempts are made to wipe off any smears with an ordinary paper or woven cloth, they rather spread out to soil the entire surface. Then, the soiled surface reflects external light and blocks the display's transmission light resulting in worsening the performance of the display device from its initial state. When a hard coat surface is provided with an antifouling property by adding a fluoroadditive, the antifouling component is also wiped off by woven cloth etc. together with smears and dust because ordinary fluoroadditive does not include a reactive group and can not adhere firmly to the hard coat layer. Thus, generally antifouling properties are often provided by forming an antifouling layer separately from the hard coat layer.

### SUMMARY OF THE INVENTION

It is a purpose of the present invention to solve these problems. The present invention provides a hard coat layer with antifouling properties without arranging another separate layer. At the same time, it is possible by using the present invention to provide a hard coat film from which smears and dust can be removed to keep the display's visual performance, adheres firmly to the substrate, hardly curls up, and has abrasion resistance and surface hardness, as well as a hard coat layer forming composition which serves to form such a hard coat film.

The first aspect of the present invention is a hard coat layer forming composition which includes a polyfunctional acrylic (or methacrylic) monomer (A), an acrylic (or methacrylic) monomer having a hydroxyl group (B), a radical photopolymerization initiator (C) and a fluorocompound having a polymerizable group (D).

The second aspect of the present invention includes the hard coat layer forming composition wherein a major component of the polyfunctional acrylic (or methacrylic) monomer (A) is a urethane acrylate (or methacrylate) monomer and/or a urethane acrylate (or methacrylate) oligomer.

The third aspect of the present invention includes the hard coat layer forming composition wherein the polyfunctional acrylic (or methacrylic) monomer (A) is included by more than (or equal to) 50% and less than (or equal to) 95% by weight relative to a sum of the polyfunctional acrylic (or methacrylic) monomer (A) and the acrylic (or methacrylic) monomer having a hydroxyl group (B).

The fourth aspect of the present invention includes the hard coat layer forming composition wherein the fluorocompound having a polymerizable group (D) is included by more than (or equal to) 0.01% and less than (or equal to) 10% by weight relative to a sum of the polyfunctional acrylic (or methacrylic) monomer (A) and the acrylic (or methacrylic) monomer having a hydroxyl group (B).

The fifth aspect of the present invention includes the hard coat layer forming composition wherein the radical photopolymerization initiator (C) is included by more than (or equal to) 0.01% and less than (or equal to) 10% by weight relative to a sum of the polyfunctional acrylic (or methacrylic) monomer (A) and the acrylic (or methacrylic) monomer having a hydroxyl group (B).

The sixth aspect of the present invention includes a hard coat film having a hard coat layer on a transparent substrate, wherein the hard coat layer is obtained by curing the hard coat layer forming composition, and a surface free energy of the hard coat layer is less than (or equal to) 20 mN/m and a thickness of the hard coat layer is in the range of 5-25 μm.

The seventh aspect of the present invention includes the hard coat film wherein a surface free energy of the hard coat layer is more than (or equal to) 15 mN/m.

The eighth aspect of the present invention includes the hard coat film wherein the transparent substrate is mainly made of triacetyl cellulose.

The ninth aspect of the present invention includes the hard coat film wherein light transmission of the hard coat film is in the range of 90-97%.

The tenth aspect of the present invention includes the hard coat film wherein haze of the hard coat film is in the range of 0.1-1.0%.

The eleventh aspect of the present invention includes the hard coat film wherein a scratch hardness of a surface of the hard coat film is a pencil hardness higher than 3H.

The twelfth aspect of the present invention includes a polarizing plate including the hard coat film wherein the transparent substrate of the hard coat layer has a polarizing layer and another transparent substrate on the opposite side from the hard coat layer.

The thirteenth aspect of the present invention includes a transmission type LCD having the polarizing plate (first polarizing plate), a liquid crystal cell, another polarizing plate (second polarizing plate), and a back light unit in the order of this description.

The present invention provides a hard coat layer forming composition with a capability of forming a hard coat layer which adheres well to the substrate, hardly curls up, and has an abrasion resistance, surface hardness and antifouling properties without forming an additional antifouling layer. In addition, smears and dust on the hard coat layer can be easily removed and the visual performance of the hard coat layer does not degrade. Furthermore, the present invention provides a hard coat film having such a hard coat layer.

### BRIEF DESCRIPTION OF THE DRAWINGS

FIG. 1 shows an explanatory cross-sectional diagram of a hard coat film of the present invention.

FIG. 2 shows an explanatory cross-sectional diagram of a polarizing plate of the present invention.

FIG. 3 shows an explanatory cross-sectional diagram of a transmission type LCD of the present invention.

### DESCRIPTION OF REFERENCE NUMERALS AND SIGNS

1: Hard coat film
11: Transparent substrate
12: Hard coat layer
2: Polarizing plate
21: Transparent substrate
22: Polarizing layer
3: Liquid crystal cell
4: Polarizing plate
41: Transparent substrate
42: Polarizing layer
43: Transparent substrate
5: Back light unit

### DETAILED DESCRIPTION OF THE INVENTION

Managing to provide a hard coat layer with antifouling properties, the inventor of the present invention found that the problems of conventional methods described above can be solved by using a hard coat layer forming composition which includes a polyfunctional acrylic (or methacrylic) monomer (A), an acrylic (or methacrylic) monomer having a hydroxyl group (B), a radical photopolymerization initiator (C) and a fluorocompound having a polymerizable group (D).

The present invention is described in detail below.

A compound of polyol, which has a plurality of alcoholic hydroxyl groups in a single molecule, esterified with an acrylic (or methacrylic) acid is preferably used as the polyfunctional acrylic (or methacrylic) monomer (A) in the hard coat layer forming composition. A compound in which a reactive acrylic group is bonded to a chain of acrylic resin, polyester acrylate, urethane acrylate, epoxy acrylate and polyester acrylate also can be used. Other than these, compounds in which an acrylic group is bonded to a rigid chain of melamine or isocyanuric acid etc. may also be used as the polyfunctional acrylic (or methacrylic) monomer (A). In particular, it is possible to improve hardness and flexibility of the hard coat layer by using urethane acrylate (or methacrylate) monomer and/or oligomer in the present invention.

In this invention, an acrylic (or methacrylic) monomer refers to both an acrylic monomer and a methacrylic monomer. For example, polyfunctional acrylic (or methacrylic) monomer means both a polyfunctional acrylic monomer and a polyfunctional methacrylic monomer. Moreover, each of a polyfunctional acrylic (or methacrylic) monomer (A) and an acrylic (or methacrylic) monomer having a hydroxyl group (B) may be an oligomer in this invention.

An example of urethane acrylate as the preferable polyfunctional acrylic (or methacrylic) monomer (A) of the present invention is a compound easily obtained by reacting an acrylic monomer having a hydroxyl group and a product of a reaction of a polyester polyol and an isocyanate monomer (or prepolymer).

Specifically, pentaerythritol triacrylate hexamethylene diisocyanate urethane prepolymer, dipantaerythritol pantaacrylate hexamethylene diisocyanate urethane prepolymer, pentaerythritol triacrylate toluene diisocyanate urethane prepolymer, dipantaerythritol pantaacrylate toluene diisocyanate urethane prepolymer, pentaerythritol triacrylate isophorone diisocyanate urethane prepolymer, and dipantaerythritol pantaacrylate isophorone diisocyanate urethane prepolymer can be used as the urethane acrylate as the preferable polyfunctional acrylic (or methacrylic) monomer (A). In addition, a mixture of these monomers can also be used. Furthermore, these monomers may remain as a monomer or form an oligomer in a coating liquid.

DIABEAM series materials (produced by Mitsubishi Rayon Co., Ltd.), DECONAL series materials (produced by Nagase ChemteX Corp.), NK Ester series materials (produced by Shin-Nakamura Chemical Co., Ltd.), UNIDIC series materials (produced by DIC Corp.), ARONIX series materials (produced by Toagosei Co., Ltd.), BLEMMER series materials (produced by NOF Corp.), KAYARAD series materials (produced by Nippon Kayaku Co., Ltd.), and LIGHT-ESTER series and LIGHT-ACRYLATE series materials (produced by Kyoeisha chemical Co., Ltd.) are commercial products which can be used as the polyfunctional acrylic (or methacrylic) monomer (A).

A polyfunctional acrylate (or methacrylate) compound is preferable as the acrylic (or methacrylic) monomer having a hydroxyl group (B) in the hard coat layer forming composition of the present invention since a polyfunctional acrylate (or methacrylate) compound blends better with the fluorocompound having a polymerizable group (D) so that a coating liquid for forming a hard coat layer hardly becomes clouded resulting in a precipitate. Hydroxyethyl acrylate, hydroxyethyl methacrylate, pentaerythritol triacrylate or dipentaerythritol pentaacrylate are desirable.

It is preferable that a usage of the polyfunctional acrylic (or methacrylic) monomer (A) is in the range of 1-99% by weight relative to a sum of the polyfunctional acrylic (or methacrylic) monomer (A) and the acrylic (or methacrylic) monomer having a hydroxyl group (B). Specifically, it is more preferable that the usage of the polyfunctional acrylic (or methacrylic) monomer (A) is in the range of 50-95% by weight. In the case where the usage of the polyfunctional acrylic (or methacrylic) monomer (A) is less than 50% by weight, hardness and a pencil hardness of the hard coat layer may become insufficient.

In the case where the usage of the polyfunctional acrylic (or methacrylic) monomer (A) is more than 95% by weight, there may be a problem that the hard coat film curls up toward the hard coat layer's side due to shrinking accompanied by hardening of the polyfunctional acrylic (or methacrylic) monomer (A). In addition, the fluorocompound having a polymerizable group (D) does not sufficiently blend in because of a relative shortage of the acrylic (or methacrylic) monomer having a hydroxyl group (B). Thus, the coating liquid may become cloudy resulting in a precipitate and there will be a problem with respect to stability of the coating liquid for forming a hard coat layer.

A compound which generates radicals by exposure to ionizing radiation and initiates a polymerization reaction of the acrylic monomer is preferable as the radical photopolymerization initiator (C) in the hard coat layer forming composition of the present invention.

Carbonyl compounds such as acetophenone, 2,2-diethoxy acetophenone, p-dimethyl acetophenone, p-dimethyl amino propiophenone, benzophenone, 2-chlorobenzophenone, 4,4′-dichlorobenzophenone, 4,4′-bis(diethylamino)benzophenone, Michler's ketone, benzil, benzoin, benzoin methyl ether, benzoin ethyl ether, benzoin isopropyl ether, p-isopropyl-′-hydroxy isobutylphenone, α-hydroxy isobutylphenone, 2,2-dimethoxy-2-phenylacetophenone, 1-hydroxycyclohexyl phenyl ketone etc., and sulfur compounds such as tetramethylthiuram monosulfide, tetramethylthiuram disulfide, thioxanetone, 2-chlorothioxanetone, 2-methylthioxanetone etc. can be used as an example of the radical photopolymerization initiator (C). A single photopolymerization initiator of these can be used alone and any combination of these together can also be used as a photopolymerization initiator.

Usage of the radical photopolymerization initiator (C) in the present invention is preferable in the range of 0.01-10% by weight relative to a sum of the polyfunctional acrylic (or methacrylic) monomer (A) and the acrylic (or methacrylic) monomer having a hydroxyl group (B) in the hard coat layer forming composition. In the case where the usage of the photopolymerization initiator is less than 0.01% by weight, cure reaction does not completely take place. In the case where the usage is more than 10% by weight, ionizing radiation does not sufficiently reach to the bottom of the hard coat layer.

With respect to the fluorocompound having a polymerizable group (D) in the hard coat layer forming composition of the present invention, it is possible to provide antifouling properties to a surface of the hard coat layer by adding a fluoroadditive. In the case where the fluoroadditive contains no polymerizable group, however, the additive will exist floating on the surface of the hard coat layer. Then, the additive is easily removed if the surface of the hard coat layer is wiped with unwoven fabric etc. This leads to a problem that the antifouling properties disappear once the surface is wiped. The present invention solves this problem by employing an antifouling fluorine compound to which a polymerizable group is introduced. This polymerizable group reacts when the hard coat layer is formed and enables the fluorine compound to be polymerized together with the hard coat layer forming composition so that antifouling properties are maintained even if the surface is wiped.

It desirable that the fluorocompound having a polymerizable group (D) in the hard coat layer forming composition of the present invention is a compound which has an acrylic (or methacrylic) group. This is because such a compound is able to make a copolymer with the polyfunctional acrylic (or methacrylic) compound and the product can be highly hardened by a radical polymerization by ionizing radiation.

OPTOOL DAC (produced by Daikin Industries, Ltd.), SUA1900L10 and SUA1900L6 (produced by Shin-Nakamura Chemical Co., Ltd.), UT3971 (produced by Nippon Synthetic Chemical Industry Co., Ltd.), DEFENSA TF3001, DEFENSA TF3000 and DEFENSA TF3028 (produced by DIC Corp.), LIGHT-PROCOAT AFC3000 (produced by Kyoeisha chemical Co., Ltd.), KNS5300 (produced by Shin-Etsu Silicones Co., Ltd.), and UVHC1105 and UVHC8550 (produced by GE Toshiba Silicones Co., Ltd.) can be used as the fluorocompound having a polymerizable group (D) of the present invention

Usage of the fluorocompound having a polymerizable group (D) in the present invention is preferable in the range of 0.01-10% by weight relative to a sum of the polyfunctional acrylic (or methacrylic) monomer (A) and the acrylic (or methacrylic) monomer having a hydroxyl group (B) in the hard coat layer forming composition. In the case where the usage is less than 0.01% by weight, the antifouling properties will be insufficient and a surface energy can exceed 20 mN/m. In the case where the usage is more than 10% by weight, the fluorocompound having a polymerizable group (D) does not blend together well with the polymerizable monomer and the solvent. Then, the coating liquid becomes clouded and results in a precipitate, which may cause a problem of defects etc. on the hard coat layer

A coat modifier, an antifoamer, a thickner, an antistat, inorganic particles, organic particles, an organic lubricant, an organic polymer, an ultraviolet absorber, a light stabilizer, a dye and a pigment can be used as a hard coat layer modifier in the present invention. These hard coat layer modifiers may be included in the hard coat layer forming composition so as to improve the quality of the hard coat layer unless they harm the curing reaction by activating light.

Irradiation of activating light, particularly ultraviolet light, is preferable as a curing method of the hard coat layer forming composition mentioned above in the present invention. In such a case, it is possible by adding a radical photopolymerization initiator to cure the hard coat layer forming composition by irradiation of ultraviolet light. Moreover, a drying process and a heating process may be arranged, if necessary.

It is desirable in the present invention that a thermal polymerization inhibitor such as hydroquinone, hydroquinone monomethyl ether or 2,5-t-butyl hydroquinone is added to the hard coat layer forming composition in order to prevent it from thermal polymerization during manufacturing or a reaction with no light during storage. It is preferable that the usage amount of the thermal polymerization inhibitor is in the range of 0.005-0.05% by weight relative to the amount of solid content in the hard coat layer forming composition.

The hard coat layer forming composition may contain a solvent if necessary. Methyl isobutyl ketone, cyclohexanone, acetone, methyl ethyl ketone, diethyl ketone, dipropyl ketone, cyclopentanone, methyl cyclohexanone, ethyl cyclohexanone, 2-butanone, ethyl formate, propyl formate, n-pentyl formate, methyl acetate, ethyl acetate, methyl propyonate, ethyl propyonate, n-pentyl acetate, γ-butyrolactone, isobutyl acetate, butyl acetate, toluene, xylene, 2-propanol, 1-butanol, cyclopentanol, diacetone alcohol, ethylene glycol monomethyl ether, propylene glycol monomethyl ether, dibutyl ether, dimethoxymethane, dimethoxyethane, diethoxyethane, propylene oxide, dioxane, dioxolan, trioxane, tetrahydrofuran, anisole, phenetol, methyl cellosolve, cellosolve, butyl cellosolve, cellosolve acetate, dichloromethane, trichloromethane, trichloroethylene, ethylene chloride, trichloroethane, tetrachloroethane, N,N-dimetyl formamide, and chloroform etc. can be used as the solvent. In addition, it is not necessary for the solvent to be made of only a single solvent. A mixture solvent can also be used.

A hard coat film can be obtained from the hard coat layer forming composition of the present invention by processes of coating on a transparent substrate and curing by exposure to activating light to form a hard coat layer.

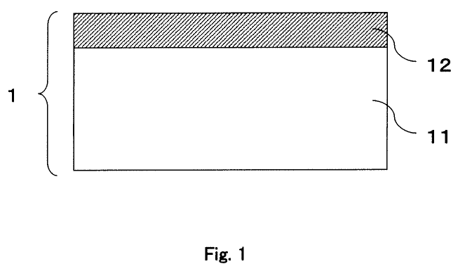

FIG. 1 illustrates an explanatory cross section diagram of the hard coat film of the present invention. The hard coat film 1 of the present invention includes the hard coat layer 12 on at least one of the surfaces of the transparent substrate 11.

The hard coat film of the present invention has the hard coat layer as the outermost layer. It is preferred in the hard coat film of the present invention that a surface energy of the hard coat layer is less than (or equal to) 20 mN/m. A surface energy less than (or equal to) 20 mN/m of the hard coat layer provides the hard coat film with a high level of antifouling properties. A hard coat film having a hard coat layer with a surface energy more than 20 mN/m can not attain sufficient antifouling properties.

Surface energy can be considered as a key factor for evaluating the antifouling properties on a surface of the hard coat layer. Antifouling properties can be estimated from a surface energy. The surface energy is obtained from a surface contact angle by extended Fowkes formula. A smaller surface energy implies better antifouling properties. In this invention, a hard coat film with a high level of antifouling properties is obtained since the surface energy is less than 20 mN/m.

In addition, it is preferred that a surface energy of the hard coat layer is more than (or equal to) 15 mN/m with respect to the hard coat film of the present invention. In general, the smaller the surface energy, the higher the level of antifouling properties in the hard coat film. A significant amount of the fluorocompound having a polymerizable group (D) is required, however, to make the surface energy of the hard coat layer less than 15 mN/m. In such a case, the hard coat layer forming composition becomes whitely clouded resulting in a whitening of the hard coat film, which is unsuitable for placing on a surface of a display device.

The thickness of the hard coat layer is determined according to a required hardness, preferably in the range of 3-30 μm (more preferably in the range of 5-25 μm). If the thickness is less than 3 μm, a hardness of the hard coat layer becomes insufficient. If the thickness exceeds 30 μm, because of shrinkage during hardening, the substrate film curls up significantly which may cause trouble such as a breakage in the subsequent processes.

It is preferable that a triacetyl cellulose (TAC) film is used as the transparent substrate in the hard coat film of the present invention. A triacetyl cellulose (TAC) film (in other words, a cellulose triacetate film) has low birefringence and a high level of transparency so as to be preferably used on a display surface, especially on an LCD surface.

In addition, it is preferred in the hard coat film of the present invention that light transmittance is in the range of 90-97%. Adjusting the light transmittance to the range stated above, the hard coat film can preferably be used on a display device. In the case where the light transmittance is less than 90%, display quality falls since a display image becomes dark when the hard coat film is placed on a surface of a display device. From the viewpoint of display quality, the larger the light transmittance is, the more desirable. It is difficult, however, to manufacture a hard coat film with light transmittance more than 97% due to the structure of a hard coat film.

In addition, it is preferred that a haze of the hard coat film of the present invention is in the range of 0.1-1.0%. If the haze is less than (or equal to) 1.0%, the hard coat film is preferably applied on a surface of a display device. In the case where the haze of the hard coat film is more than 1.0%, a display image on a surface of the display device is blurred resulting in a decrease of display quality when the hard coat film is applied on the surface of the display. From a viewpoint of display quality, the smaller the haze is, the more desirable. It is difficult, however, to manufacture a hard coat film with a haze less than 0.1% due to the structure of a hard coat film.

In addition, it is preferred in the hard coat film of the present invention that a pencil hardness of the hard coat layer surface is higher than 3H. A hard coat layer surface with a pencil hardness more than (or equal to) 3H provides sufficient surface hardness to the hard coat layer so that a hard coat film with excellent abrasion resistance is obtained.

In addition, a function layer is arranged on the hard coat film of the present invention if necessary. The function layer is arranged between the transparent substrate and the hard coat layer or on a surface of the other transparent substrate from the transparent substrate on which the hard coat layer is formed. Examples of the function layer are an antireflection layer, an antistatic layer, an antiglare layer, an electromagnetic shielding layer, an infrared absorbing layer, an ultraviolet layer and color compensation layer etc. These function layers can take both structure types of a single layer structure and a multilayer structure. The hard coat film in which a hard coat layer (or further, a functional layer as well) is formed on a transparent substrate can be placed on a variety of displays such as LCD, PDP and CRT display so that the display has a high level of abrasion resistance and antifouling properties.

A sufficient translucency and mechanical strength is required to the transparent substrate and a film with appropriate transparency is preferable as the transparent substrate. For example, polyethylene terephthalate (PET), triacetyl cellulose (TAC), diacetyl cellulose, acetylcellulose butylate, polyethylene naphthalate (PEN), a certain kind of cycloolefine polymer, polyimide, polyether sulfone (PES), polymethyl methacrylate (PMMA), and polycarbonate (PC) etc. can be used as the transparent substrate. In particular, TAC is preferably used as the transparent substrate when the hard coat film is applied on a frontal surface of an LCD because of its optical isotropy. The thickness of the transparent substrate is preferably in the range of 20-200 μm (more preferably in the range of 40-80 μm).

The manufacturing method of the hard coat film of the present invention includes a coating process in which the hard coat layer forming composition is coated on the transparent substrate and a curing process in which the hard coat layer forming composition on the transparent substrate exposed to activation light to be cured. Besides these, a drying process in which the solvent is removed can be arranged. In addition, a heating process may also be arranged after the curing process.

Regarding the coating process, the hard coat layer forming composition can be coated by a conventional method such as a bar coat method, an applicator method, a doctor blade method, roll coating method, die coating method, a comma coating method and a gravure coating method.

Ultraviolet light and electron beam can be used as the activation light with which the hard coat layer composition coated on the transparent substrate cures. As for ultraviolet, a high pressure mercury lamp, a low pressure mercury lamp, an ultra-high pressure mercury lamp, a metal halide lamp, carbon arc and xenon arc etc. can be used as a light source. As for electron beam, electron beams from various electron accelerators such as Cockcroft-Walton accelerator, van de Graaff accelerator, resonant transformer accelerator, insulated core transformer accelerator, linear accelerator, dynamitron accelerator, or high frequency accelerator can be used.

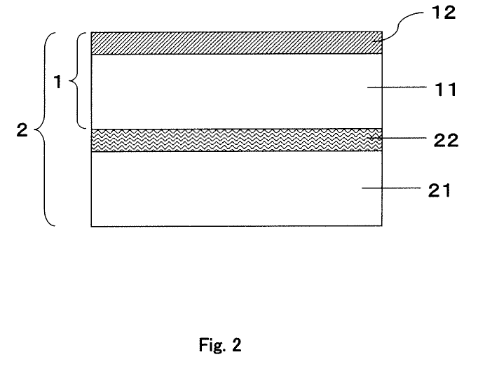

FIG. 2 shows an explanatory cross sectional diagram of the polarizing plate of the present invention. The transparent substrate 11 in the polarizing plate 2 of the present invention has a polarizing layer 22 and another transparent substrate 21 on the opposite side 11 from the hard coat layer 12. The polarizing layer 22 is arranged between a pair of the transparent substrates 11 and 21 in the polarizing plate 2 of the present invention. It is preferable that the same material as the transparent substrate 11 of the hard coat film 1 is used as a material of the transparent substrate 21 and a triacetyl cellulose film is desirable as the transparent substrate 11. Iodine added enhanced polyvinyl alcohol (PVA), for example, can be used as the polarizing layer 22.

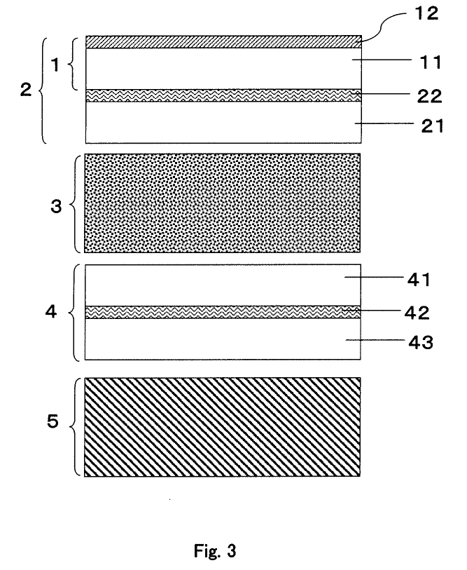

FIG. 3 illustrates an explanatory cross section diagram of a transmission type LCD of the present invention. The LCD of the present invention has the polarizing plate 2 including the hard coat film 1, a liquid crystal cell 3, another polarizing plate 4 and a back light unit 5 in the order of this description from a side of the display's user. The hard coat layer 12 is arranged on the outermost side of the display device and nearest to the user.

The back light unit 5 has a light source and a light diffusion plate. The liquid crystal cell 3 has an electrode and a color filter on one transparent substrate and the other electrode on the other transparent substrate. Then, a liquid crystal is inserted between the electrodes and sealed. Each of the polarizing plates 2 and 4 takes a structure arranging the polarizing layers 22, 42 between the transparent substrates 11, 21, 41, 43. A liquid crystal cell 3 is sandwiched between a pair of polarizing plates 2 and 4.

In addition, the transmission type LCD may also include other functional components. A light diffusion film, a prism sheet and a luminance improving film, which effectively utilize light from a source, and a retardation film, which compensates a difference in phase of light on a polarizing plate or a liquid crystal cell, are typical examples of the other functional components. This invention, however, is not limited to these examples.

### EXAMPLES

The present invention is described in detail with examples below. These examples, however, do not limit the present invention. Performance and properties of the hard coat film were evaluated as follows.
Haze: The measurement was performed with NDH-2000 (made by Nippon Denshoku Industries Co., Ltd.) conforming to JIS (Japanese Industrial Standards)—K7105.
Light transmittance: The measurement was performed with NDH-2000 (made by Nippon Denshoku Industries Co., Ltd.) conforming to JIS (Japanese Industrial Standards)—K7105.
Pencil hardness: The evaluation was carried out conforming to JIS (Japanese Industrial Standards)—K5400.
Abrasion resistance: After a steel wool of #0000 was moved 10 laps with a load of 250 g/cm², it was checked whether scratch marks or flaws were observed or not.

◯: No scratch marks or flaws were observed.

×: Scratch marks or flaws were observed.
Antifouling properties: The hard coat layer was attached with smears of a fingerprint on the surface and was wiped with an unwoven cellulose fabric (BemcotM-3 made by Asahi Kasei Corp.) under a load of 250 250 g/cm². Ease of removing the smears was visually checked. Criteria were as follows.

◯: Smears were completely removed.

Δ: Smears were partially removed.

×: No smears were removed.
Surface energy: A droplet with a diameter of 1.8 mm was formed on the tip of a needle by a contact angle meter (CA-X type: made by Kyowa Interface Science Co., Ltd.) under a dry condition (20° C., 65% RH). Then, the droplet and the sample (a solid object) were brought into contact with each other and measured. The contact angle herein is defined as the angle between the surface of the solid object and the tangent surface to the droplet (referring to the angle which includes the droplet side). The droplet was made by distilled water and n-hexadecane, respectively. The surface energy was calculated by the extended Fowkes formula on the basis of the results of the contact angles corresponding to these two liquids.

### Example 1

The hard coat layer was formed as follows:
Urethane acrylate: UA-306H (made by Kyoeisha Chemical Co., Ltd.) 80 parts by weight, Acryl monomer: PE-3A (pentaerythritol triacrylate, made by Kyoeisha Chemical Co., Ltd.) 10 parts by weight, Initiator: Irgacure 184 (made by Ciba Specialty Chemicals) 1.5 parts by weight, Fluoroadditive: OPTOOL DAC (made by Daikin Industries) 0.5 parts by weight, Solvent: ethyl acetate 100 parts by weight were mixed and stirred to prepare the coating liquid. The coating liquid was coated on an 80 μm thick TAC film substrate by bar coat method, dried and exposed to ultraviolet light with 400 mJ/cm² from a metal halide lamp so that the hard coat film with 12 μm of thickness after hardening was obtained. The measurement results of the light transmittance, the haze, the abrasion resistance test, the pencil hardness, and the antifouling properties are summarized and shown in table 1.

### Example 2

The hard coat layer was formed as follows:
Urethane acrylate: UV-1700B (made by Nippon Synthetic Chemical Industry Co., Ltd.) 80 parts by weight, Acryl monomer: PE-3A (made by Kyoeisha Chemical Co., Ltd.) 10 parts by weight, Initiator: Irgacure 184 (made by Ciba Specialty Chemicals) 1.5 parts by weight, Fluoroadditive: OPTOOL DAC (made by Daikin Industries) 0.5 parts by weight, Solvent: ethyl acetate 100 parts by weight were mixed and stirred to prepare the coating liquid. The coating liquid was coated on an 80 μm thick TAC film substrate by bar coat method, dried and exposed to ultraviolet light with 400 mJ/cm² from a metal halide lamp so that the hard coat film with 12 μm of thickness after hardening was obtained. The measurement results of the light transmittance, the haze, the abrasion resistance test, the pencil hardness, and the antifouling properties are summarized and shown in table 1.

### Example 3

The hard coat layer was formed as follows:
Urethane acrylate: UA-306H (made by Kyoeisha Chemical Co., Ltd.) 80 parts by weight, Acryl monomer: PE-3A (made by Kyoeisha Chemical Co., Ltd.) 10 parts by weight, Initiator: Irgacure 184 (made by Ciba Specialty Chemicals) 1.5 parts by weight, Fluoroadditive: DIFENSA TF3001 (made by DIC Corp.) 1.0 parts by weight, Solvent: ethyl acetate 100 parts by weight were mixed and stirred to prepare the coating liquid. The coating liquid was coated on an 80 μm thick TAC film substrate by bar coat method, dried and exposed to ultraviolet light with 400 mJ/cm² from a metal halide lamp so that the hard coat film with 12 μm of thickness after hardening was obtained. The measurement results of the light transmittance, the haze, the abrasion resistance test, the pencil hardness, and the antifouling properties are summarized and shown in table 1.

### Example 4

The hard coat layer was formed as follows:
Urethane acrylate: UA-306H (made by Kyoeisha Chemical Co., Ltd.) 80 parts by weight, Acryl monomer: PE-3A (made by Kyoeisha Chemical Co., Ltd.) 10 parts by weight, Initiator: Irgacure 184 (made by Ciba Specialty Chemicals) 1.5 parts by weight, Fluoroadditive: OPTOOL DAC (made by Daikin Industries) 0.5 parts by weight, Solvent: methyl isobutyl ketone 100 parts by weight were mixed and stirred to prepare the coating liquid. The coating liquid was coated on an 80 μm thick TAC film substrate by bar coat method, dried and exposed to ultraviolet light with 400 mJ/cm² from a metal halide lamp so that the hard coat film with 12 μm of thickness after hardening was obtained. The measurement results of the light transmittance, the haze, the abrasion resistance test, the pencil hardness, and the antifouling properties are summarized and shown in table 1.

### Comparative Example 1

The hard coat layer was formed as follows:
Urethane acrylate: UA-306H (made by Kyoeisha Chemical Co., Ltd.) 80 parts by weight, Acryl monomer: PE-3A (made by Kyoeisha Chemical Co., Ltd.) 10 parts by weight, Initiator: Irgacure 184 (made by Ciba Specialty Chemicals) 1.5 parts by weight, Nonpolymerizable fluoroadditive: MEGAFACE F-470 (made by DIC) 1.0 parts by weight, Solvent: ethyl acetate 100 parts by weight were mixed and stirred to prepare the coating liquid. The coating liquid was coated on an 80 μm thick TAC film substrate by bar coat method, dried and exposed to ultraviolet light with 400 mJ/cm² from a metal halide lamp so that the hard coat film with 12 μm of thickness after hardening was obtained. The measurement results of the light transmittance, the haze, the abrasion resistance test, the pencil hardness, and the antifouling properties are summarized and shown in table 1.

### Comparative Example 2

The hard coat layer was formed as follows:
Urethane acrylate: UA-306H (made by Kyoeisha Chemical Co., Ltd.) 80 parts by weight, Acryl monomer: PE-3A (made by Kyoeisha Chemical Co., Ltd.) 10 parts by weight, Initiator: Irgacure 184 (made by Ciba Specialty Chemicals) 1.5 parts by weight, Silicone additive: BYK-UV3500 (made by BYK-Chemie) 1.0 parts by weight, Solvent: ethyl acetate 100 parts by weight were mixed and stirred to prepare the coating liquid. The coating liquid was coated on an 80 μm thick TAC film substrate by bar coat method, dried and exposed to ultraviolet light with 400 mJ/cm² from a metal halide lamp so that the hard coat film with 12 μm of thickness after hardening was obtained. The measurement results of the light transmittance, the haze, the abrasion resistance test, the pencil hardness, and the antifouling properties are summarized and shown in table 1.

### Comparative Example 3

Urethane acrylate: UA-306H (made by Kyoeisha Chemical Co., Ltd.) 80 parts by weight, Initiator: Irgacure 184 (made by Ciba Specialty Chemicals) 1.5 parts by weight, Silicone additive: OPTOOL DAC (made by Daikin Industries) 0.5 parts by weight, Solvent: ethyl acetate 100 parts by weight were mixed and stirred to prepare the coating liquid. The coating liquid, however, became whitely clouded and it was impossible to obtain the hard coat film to evaluate properties.

### Comparative Example 4

Urethane acrylate: UA-306H (made by Kyoeisha Chemical Co., Ltd.) 90 parts by weight, Acryl monomer: TMPTA (made by Kyoeisha Chemical Co., Ltd.) 10 parts by weight, Initiator: Irgacure 184 (made by Ciba Specialty Chemicals) 1.5 parts by weight, Silicone additive: OPTOOL DAC (made by Daikin Industries) 0.5 parts by weight, Solvent: ethyl acetate 100 parts by weight were mixed and stirred to prepare the coating liquid. The coating liquid, however, became whitely clouded and it was impossible to obtain the hard coat film to evaluate properties. TMPTA was an acrylic monomer having no hydroxyl group.

The results of the example 1 to 4 and the comparative example 1 and 2 stated above are shown in table 1.

TABLE 1

| | Light | | Abrasion | Pencil | Antifouling | Surface |
|---|---|---|---|---|---|---|
| | transmittance | Haze | resistance | hardness | properties | energy |
| Example 1 | 92% | 0.2% | ◯ | 3 H | ◯ | 17.6 mN/m |
| Example 2 | 93% | 0.2% | ◯ | 4 H | ◯ | 16.9 mN/m |
| Example 3 | 92% | 0.2% | ◯ | 3 H | ◯ | 18.9 mN/m |
| Example 4 | 92% | 0.2% | ◯ | 3 H | ◯ | 17.9 mN/m |
| Comparative | 92% | 0.2% | ◯ | 3 H | Δ | 20.5 mN/m |
| example 1 | | | | | | |
| Comparative | 92% | 0.2% | ◯ | 3 H | X | 24.5 mN/m |
| example 1 | | | | | | |

Comparing the results of example 1 to 4 and comparative examples 1 and 2, it was concluded that a hard coat film with sufficient surface energy and antifouling properties can be obtained by adding fluorocompound having a polymerizable group. In addition, comparing the results of example 1 to 4 and comparative examples 3 and 4, it turned out that solubility of the fluoroadditive to the coating liquid was improved by using acrylic (or methacrylic) monomer.

What is claimed is:

1. A hard coat layer forming composition comprising:
a polyfunctional acrylic or methacrylic monomer (A);
an acrylic or methacrylic monomer having a hydroxyl group (B);
a radical photopolymerization initiator (C); and
a fluorocompound having a polymerizable group (D).

2. The hard coat layer forming composition in accordance with claim 1, wherein a major component of said polyfunctional acrylic or methacrylic monomer (A) is a urethane acrylate or methacrylate monomer and/or a urethane acrylate or methacrylate oligomer.

3. The hard coat layer forming composition in accordance with claim 1, wherein said polyfunctional acrylic or methacrylic monomer (A) is contained in the range of 50-95% by weight relative to a sum of said polyfunctional acrylic or methacrylic monomer (A) and said acrylic or methacrylic monomer having a hydroxyl group (B).

4. The hard coat layer forming composition in accordance with claim 1, wherein said fluorocompound having a polymerizable group (D) is added in the range of 0.01-10% by weight relative to a sum of said polyfunctional acrylic or methacrylic monomer (A) and said acrylic or methacrylic monomer having a hydroxyl group (B).

5. The hard coat layer forming composition in accordance with claim 1, wherein said radical photopolymerization initiator (C) is added in the range of 0.01-10% by weight relative to a sum of said polyfunctional acrylic or methacrylic monomer (A) and said acrylic or methacrylic monomer having a hydroxyl group (B).

6. A hard coat film comprising a hard coat layer which is formed on a transparent substrate by curing said hard coat layer forming composition in accordance with claim 1, wherein
a surface free energy of said hard coat layer is less than or equal to 20 mN/m and the thickness of said hard coat layer is in the range of 5-25 μm.

7. The hard coat film in accordance with claim 6, wherein said surface free energy of said hard coat layer is more than or equal to 15 mN/m.

8. The hard coat film in accordance with claim 6, wherein said transparent substrate is mainly made of triacetyl cellulose.

9. The hard coat film in accordance with claim 6, wherein the light transmittance of said hard coat film is in the range of 90-97%.

10. The hard coat film in accordance with claim 6, wherein a haze of said hard coat film is in the range of 0.1-1.0%.

11. The hard coat film in accordance with claim 6, wherein a pencil hardness of said hard coat film is higher than or equal to 3H.

12. A polarizing plate comprising said hard coat film in accordance with claim 6, wherein
said transparent substrate has a polarizing layer and another transparent substrate on the opposite side from said hard coat layer.

13. A transmission type LCD comprising:
said polarizing plate in accordance with claim 12;
a liquid crystal cell;
a polarizing plate; and
a back light unit, in the order of this description.
